(19) United States
(12) Patent Application Publication
(10) Pub. No.: US 2024/0399833 A1
(43) Pub. Date: Dec. 5, 2024

(54) Air-Curtain System of Vehicle

(71) Applicants: Hyundai Motor Company, Seoul (KR); Kia Corporation, Seoul (KR); Doowon Climate Control Co., LTD., Asan-si (KR)

(72) Inventors: Su Yeon Kang, Seoul (KR); Kwang Ok Han, Seoul (KR); Il Young Noh, Asan-si (KR)

(21) Appl. No.: 18/385,447

(22) Filed: Oct. 31, 2023

(30) Foreign Application Priority Data
May 31, 2023 (KR) 10-2023-0070389

(51) Int. Cl. B60H 1/24

(52) U.S. Cl. CPC B60H 1/245; B60H 1/243; B60H 1/244; B60H 2001/00185

(57) ABSTRACT

Proposed is an air-curtain system of a vehicle. The system may include a plurality of air discharge units provided on a roof of a door side or trunk side of the vehicle and adjusting a direction or pressure of discharged air, an air supply system connected at a plurality of ends to the air discharge units and adjusting supply of the air to the air discharge unit as a plurality of guides provided therein are rotated, and a controller adjusting a flow rate of the air discharged from the air discharge unit by adjusting a rotation angle of each of the guides depending on an open or closed state of a door or trunk of the vehicle.

### CROSS REFERENCE TO RELATED APPLICATIONS

The present application claims priority to Korean Patent Application No. 10-2023-0070389, filed May 31, 2023, the entire contents of which is incorporated herein for all purposes by this reference.

### BACKGROUND

Air conditioning is ubiquitous, for example, in spaces such as vehicles and buildings. If such air-conditioned spaces are opened, for example, via a door to an external environment, the desirable air of the conditioned space and the undesirable air of the external environment may mix.

### SUMMARY

Systems, apparatuses and methods are described for an air-curtain of a vehicle. The air-curtain may comprise an air-curtain system. The air-curtain system may include a plurality of air discharge units provided on a roof of a door side or trunk side of the vehicle. Each of the plurality of air discharge units may be configured to adjust a direction or pressure of air discharged thereby by driving an actuator. The air-curtain system may further include an air supply system provided in the vehicle, connected at a plurality of ends to the plurality of air discharge units. The air supply system may be configured to adjust a supply of the air to each of the plurality of air discharge units as a plurality of guides provided therein are rotated. Additionally, a controller may be configured to cause an adjustment to a flow rate of the air discharged from one or more of the air discharge units by causing an adjustment to a rotation angle of one or more of the plurality of guides depending on an open or closed state of a door or trunk of the vehicle.

These and other features and advantages are described below in greater detail.

### BRIEF DESCRIPTION OF THE DRAWINGS

FIG. 1 is a view illustrating an example air-curtain system of a vehicle.

FIG. 2 is a view illustrating an example air discharge unit of the air-curtain system of a vehicle.

FIG. 3, FIG. 4, and FIG. 5 are sectional views taken along line A-A′ of FIG. 2 as an actuator is driven.

FIG. 6 is a side view illustrating an example air-curtain system of a vehicle.

### DETAILED DESCRIPTION

Hereafter, aspects of the present disclosure will be described in detail with reference to the accompanying drawings and the same or similar components are given the same reference numerals regardless of the numbers of figures and are not repeatedly described.

In the following description, if it is decided that the detailed description of known technologies related to the present disclosure makes the subject matter of the examples described herein unclear, the detailed description is omitted. Further, the accompanying drawings are provided only for easy understanding of examples disclosed in the specification, and the technical spirit disclosed in the specification is not limited by the accompanying drawings, and all changes, equivalents, and replacements should be understood as being included in the spirit and scope of the present disclosure.

Terms including ordinal numbers such as “first”, “second”, etc. may be used to describe various components, but the components are not to be construed as being limited to the terms. The terms are used only to distinguish one component from another component.

Singular forms are intended to include plural forms unless the context clearly indicates otherwise.

It will be further understood that the terms “comprise” or “have” used in this specification, specify the presence of stated features, steps, operations, components, parts, or a combination thereof, but do not preclude the presence or addition of one or more other features, numerals, steps, operations, components, parts, or a combination thereof.

It is to be understood that if one element is referred to as being “connected to” or “coupled to” another element, it may be connected directly to or coupled directly to another element or be connected to or coupled to another element, having the other element intervening therebetween. On the other hand, it should to be understood that if one element is referred to as being “connected directly to” or “coupled directly to” another element, it may be connected to or coupled to another element without the other element intervening therebetween.

Further, a controller may include a communication device that communicates with other controllers or sensors to control a function in charge, a memory that stores an operating system or a logic command and input/output information, and one or more processors that perform judgment, computation, decision, and the like for controlling a function in charge.

An air-curtain system of a vehicle according to the present disclosure may include a plurality of air discharge units 100 provided on a roof of a door side or trunk side of the vehicle and adjusting a direction or pressure of discharged air by driving an actuator 150, an air supply system 200 provided in the vehicle, connected at a plurality of ends to the air discharge units 100, and adjusting supply of the air to the air discharge unit 100 as a plurality of guides 210 provided therein are rotated, and a controller 300 adjusting a flow rate of the air discharged from the air discharge unit 100 by adjusting a rotation angle of each of the guides depending on an open or closed state of a door or trunk of the vehicle.

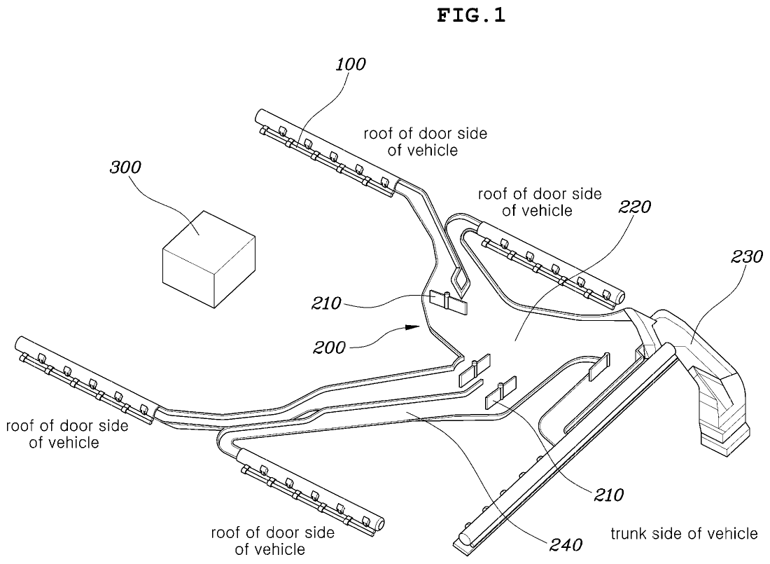

FIG. 1 is a view illustrating an example air-curtain system of a vehicle.

The air-curtain system of the vehicle may be operated using a Heating Ventilation and Air Conditioning (HVAC) system that is basically installed in the vehicle.

That is, if an air-curtain function is not required, the HVAC system for conditioning air in the interior space of the vehicle is basically operated. If the air-curtain function is required, the air-curtain function may be automatically performed by a user's request or the control of the controller 300.

FIG. 1 shows the air-curtain system provided on a roof side of the vehicle. The air discharge unit 100 may be configured to receive air from an air supply system 200 and discharge the air to the interior space of the vehicle.

The air supply system 200 may be configured to deliver air inside the vehicle or air outside the vehicle to the air discharge unit 100. The air supply system 200 may deliver air, which may be dehumidified or humidified, for example, by heating or cooling the air, to the air discharge unit 100. To this end, the air supply system may include a compressor, an evaporator core, a heater, a blower, etc.

A guide 210 may be provided in the air supply system 200. The guide 210 may adjust the flow rate of air delivered from the air supply system 200 to the air discharge unit 100 by rotation.

That is, as shown in FIG. 1, the guide 210 may rotate at a predetermined rotation angle to the maximum to prevent air from being delivered to the air discharge unit 100, or may rotate to the maximum to allow air to be delivered to the air discharge unit 100.

The air discharge unit 100 receiving air from the air supply system 200 may discharge the air to the interior space of the vehicle. At this time, the air discharge direction or the air discharge pressure may be changed by driving an actuator 150 that may be provided in the air supply system 200. The actuator 150 may be driven by a user or by the controller 300.

Details of the air discharge direction control and the discharge pressure control by driving the actuator 150 will be described later.

On the other hand, the air discharge unit 100 may be provided on a door-side roof of the vehicle or a trunk-side roof of the vehicle. However, the position of the air discharge unit 100 is not limited thereto, but the air discharge unit may be provided where an opening that opens the vehicle to an external space, such as a door or trunk of the vehicle, is located, so the air discharge unit may perform the air-curtain function if necessary.

The controller 300 adjusts the rotation angle of the guide 210 depending on the open or closed state of the door or trunk of the vehicle, thus adjusting the flow rate of the air discharged from the air discharge unit 100.

That is, if it is detected that the door or trunk of the vehicle is open, the controller 300 may rotate the guide 210 to increase the flow rate of the air discharged from the air discharge unit 100. On the contrary, if it is detected that the door or trunk of the vehicle is closed, the controller may rotate the guide 210 to reduce the flow rate of the air discharged from the air discharge unit 100.

As an example, if the door or trunk of the vehicle is opened by a passenger or a person attempting to get into the vehicle while the vehicle is stopped, the controller 300 may rotate the guide 210 to increase the flow rate of the air discharged from the air discharge unit 100, thereby preventing air inside the vehicle from being mixed with air outside the vehicle.

If the door or trunk of the vehicle is closed, the controller 300 may rotate the guide 210 to reduce the flow rate of the air discharged from the air discharge unit 100, thereby adjusting the flow rate of the air to be suitable for the air conditioning of the vehicle.

The flow rate of the air discharged from the air discharge unit 100 may be adjusted by adjusting the rotation angle of the guide 210. However, the flow rate of the discharged air may be adjusted by lowering or increasing the rotation speed of a blower included in the air supply system 200.

The above-described air-curtain function of the vehicle prevents the air in the interior space of the vehicle from being mixed with the air in the external space if necessary, thereby keeping the indoor air of the vehicle pleasant. That is, since the air having the increased flow rate due to the air-curtain function is discharged from the air discharge unit, a temporary interface may be formed so that the diffusion of air inside the vehicle to the outside of the interface may be blocked and the diffusion of air outside the vehicle to the inside of the interface may be blocked, thereby preventing the air inside the vehicle from being mixed with the air outside the vehicle.

Thus, the temperature of the air in the interior space of the vehicle can be kept constant, and foreign substances such as fine dust and pollen scattered in the outdoor space can be prevented from entering the interior of the vehicle.

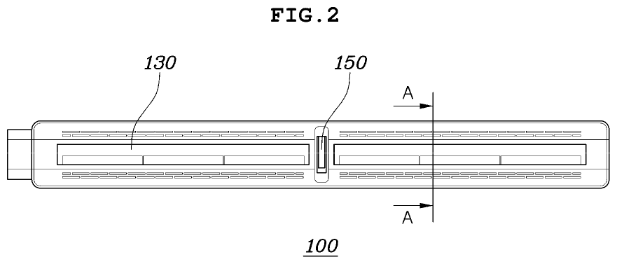

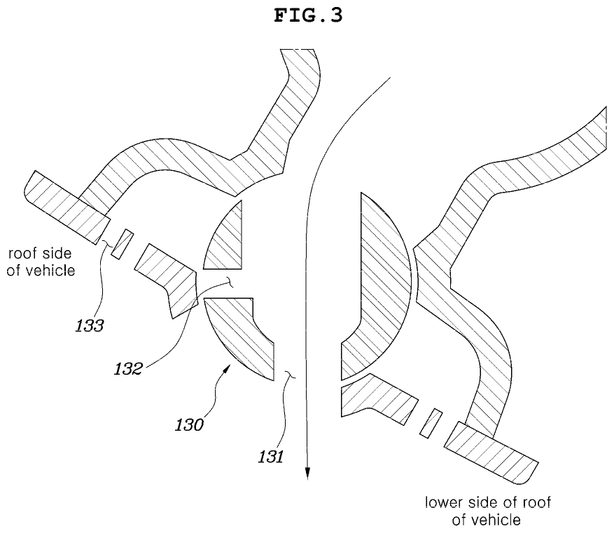

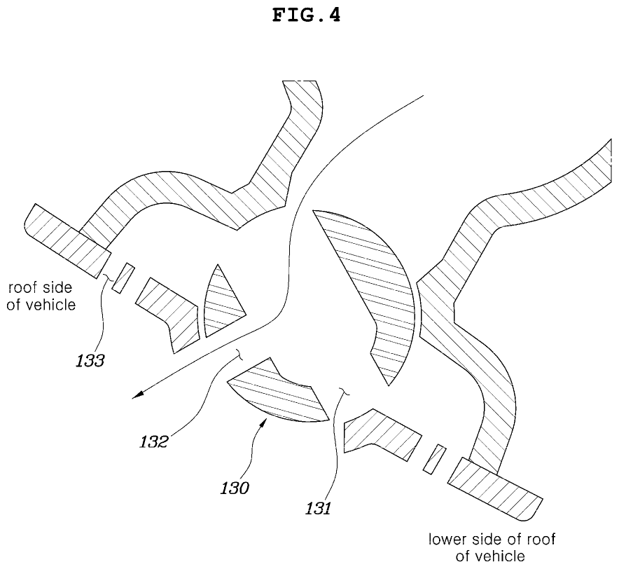

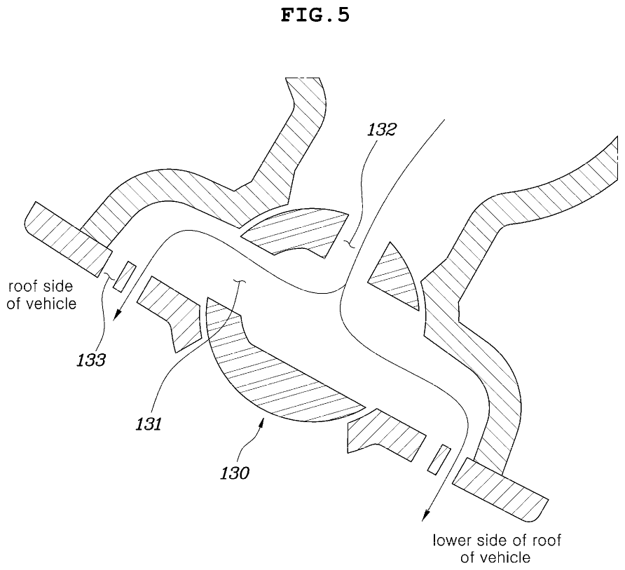

FIG. 2 is a view illustrating an example air discharge unit of the example air-curtain system of a vehicle, and FIGS. 3 to 5 are sectional views taken along line A-A′ of FIG. 2 as the actuator is driven.

The controller 300 may drive the actuator 150 depending on the open or closed state of the door or trunk of the vehicle, thus adjusting the direction or pressure of the air discharged from the air discharge unit 100.

Specifically, the actuator 150 may be driven by a passenger in the vehicle, but may be driven by the controller 300 to adjust the direction or pressure of the air discharged from the air discharge unit 100.

That is, in a general air conditioning situation, the actuator 150 may be driven to discharge air toward the roof of the vehicle. However, if the controller 300 detects that the door or trunk of the vehicle is open, the actuator 150 may be driven, so the direction of the air discharged from the air discharge unit 100 may be changed to the lower side of the roof, and the pressure of the air discharged from the air discharge unit 100 may be increased to activate the air-curtain function.

Further, if the controller 300 detects that the door or trunk of the vehicle is closed, the actuator 150 may be driven to change the direction of the air discharged from the air discharge unit 100 to the roof side and lower the pressure of the air discharged from the air discharge unit 100, thus allowing the general air conditioning operation to be performed.

On the other hand, the air discharge unit 100 may include a discharge port 130 through which the air may be discharged. The discharge port 130 may be rotated by driving the actuator 150 to discharge the air to the roof or the lower side of the roof.

Referring to FIGS. 2 to 5, the discharge port 130 may be rotated by driving the actuator 150. As the discharge port 130 rotates, the air discharge direction and the air discharge pressure may be adjusted.

To be more specific, the discharge port 130 may include a first discharge port 131 that may be relatively large in sectional area through which air may be discharged, and a second discharge port 132 that may be relatively small in sectional area through which air may be discharged. The sectional area of the second discharge port may be relatively smaller than the sectional area of the first discharge port. If the discharge port 130 is rotated by driving the actuator 150, the air may be selectively discharged from the first discharge port 131 or the second discharge port 132.

That is, if it is desired to discharge air having similar pressure through the first discharge port 131 and the second discharge port 132, the first discharge port 131 has a relatively large sectional area to be suitable for blowing a large amount of air, and the second discharge port 132 has a relatively small sectional area to be suitable for blowing a small amount of air.

On the other hand, the air discharge unit 100 may include a third discharge port 133 as well as the first discharge port 131 and the second discharge port 132. If there is no air discharged to the first and second discharge ports 131 and 132 by driving the actuator 150, the air delivered from the air supply system 200 may be discharged to the interior space of the vehicle through the third discharge port 130. Since the third discharge port 130 distributes air and discharges it to the roof side and the lower side of the roof of the vehicle, an area where a passenger is directly exposed to the discharged air may be reduced.

Accordingly, the conditioned air may be discharged to the interior space through the third discharge port 130 as well as the first and second discharge ports 131 and 132 according to a passenger's preference.

Further, the air supply system 200 may include a roof duct 220 which may be provided in the roof and may be a passage through which air flows, and a branch duct 240 may be provided on each end of the roof duct 220 to be connected to the air discharge unit 100.

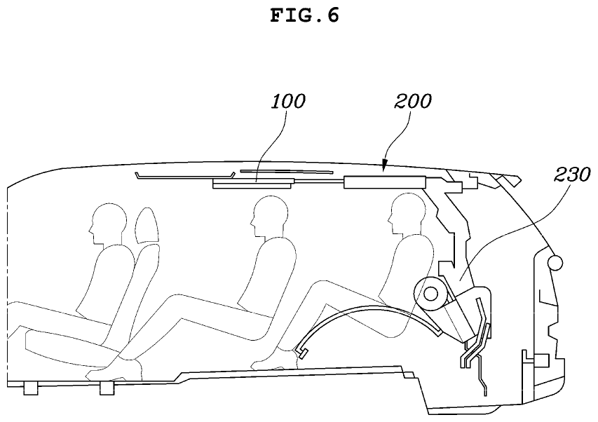

FIG. 6 is a side view illustrating an example air-curtain system of a vehicle. Referring to FIGS. 1 and 6, the roof duct 220 of the air supply system 200 may receive air conditioned by the HVAC system and then deliver the air to the branch duct 240 that may be provided on each end of the roof duct 220. The guide 210 provided on the roof duct 220 may be provided on a front end of the branch duct 240, so the flow rate of air introduced into the branch duct 240 may be adjusted by the rotation of the guide 210. The air discharge unit 100 may be connected to the end of the branch duct 240 to discharge the conditioned air to the interior of the vehicle.

Further, the roof duct 220 may be connected to a main duct 230 that is provided on a rear side of the vehicle to receive air from the main duct 230. The main duct 230 may be a duct located in a D pillar of the vehicle, and functions to deliver the air conditioned by the HVAC system to the roof duct 220. The branch duct 240 may be provided in the roof where the door or trunk of the vehicle is located.

According to the type of the vehicle, there may be no vehicle door on the side of a seat where the passenger sits. Even if there is no vehicle door, the air discharge unit 100 may be provided on the roof of a seat side having no vehicle door to deliver air conditioned by the HVAC system and to perform the air-curtain function as needed.

However, if there is no vehicle door on the side of the seat, there is no opening near the seat, so the indoor air of the vehicle may rarely mix with the outdoor air and thereby it may be predominantly unnecessary to activate the air-curtain function. The air discharge unit 100 provided on the roof of the seat side having no vehicle door may be configured relatively simply compared to the air discharge unit 100 provided on the roof around the opening.

On the other hand, if the controller 300 detects that the door or trunk of the vehicle is open, the air may be discharged to the air discharge unit 100 on the side where the opening is detected.

To be more specific, the air-curtain function prevents the indoor air of the vehicle from being mixed with the outdoor air, thus keeping the interior space of the vehicle comfortable. Therefore, though not limiting, it may be preferable to perform the air-curtain function only where the indoor air of the vehicle may be mixed with the outdoor air.

Therefore, it may be sufficient that the controller 300 detects the open place of the vehicle door and controls such that the air discharge unit 100 discharges the air on a side where the vehicle door is open.

For example, if the vehicle doors of a driver's seat and a front passenger seat are open and the door on the side of a rear seat is closed, the controller 300 may control the air discharge unit 100 located on each of the door sides of the driver's seat and passenger seat of the vehicle to discharge the air.

Similarly, if it is detected that the door or trunk of the vehicle is open, the controller 300 may adjust the rotation angle of the guide 210 on the open side, thus increasing the flow rate of the air discharged from the air discharge unit 100, or may drive the actuator 150, thus increasing the pressure of the discharged air, and thereby activating the air-curtain function.

On the other hand, depending on the condition of the outdoor or indoor air, air may contact a rear glass to form condensation or frost. In this case, a user may request the dehumidification of the rear glass through the controller 300. If the user requests the dehumidification of the rear glass, the controller 300 may increase the air flow rate of the air discharge unit 100 on the trunk side to dehumidify the rear glass.

In other words, the air discharge unit 100 may remove condensation or frost formed on the rear glass by spraying air dried by the HVAC system onto the rear glass provided on the trunk side.

If the user requests air conditioning inside the vehicle, the controller 300 may adjust the rotation of the guide 210 and the driving of the actuator 150, thus adjusting the direction or pressure of the air discharged from the air discharge unit 100.

The air-curtain system of the vehicle according to the present disclosure basically utilizes the air conditioning system of the vehicle. Therefore, if the air-curtain function is not required, air conditioning may be performed to condition the indoor air of the vehicle.

The controller 300 may rotate the guide 210 if the user requests air conditioning (heating, cooling, dehumidification, etc.) inside the vehicle to discharge the conditioned air through the air discharge unit 100 to the interior space, and may drive the actuator 150 to change the air discharge direction and thereby discharge the air to the roof side of the vehicle.

Further, the controller 300 may determine whether there is a passenger for each seat, and may adjust the air discharge direction of the air discharge unit 100 depending on the presence of the passenger. The controller 300 may detect the presence or absence of the passenger for each seat through a signal transmitted from a camera installed in the vehicle or a load cell installed in the seat.

If it is determined that the passenger sits on the seat, the controller 300 may change the air discharge direction of the air discharge unit 100 to the roof side of the vehicle. If it is determined that no passenger sits on the seat, the controller 300 may discharge the air while periodically changing the air discharge direction of the air discharge unit 100.

If it is detected that the door or trunk of the vehicle is open while the indoor air conditioning is in progress, the controller 300 may adjust the rotation angle of the guide 210 on the side where the opening is detected, thus increasing the flow rate of the air discharged from the air discharge unit 100.

Any act or function described herein as being performed by a controller (e.g., the controller 300) may comprise a function or act directly or indirectly caused by the controller.

The flow rate of the air may be increased by adjusting the rotation angle of the guide 210. However, in some cases, the flow rate of the air may be increased by increasing the rotation speed of the blower.

An objective of the present disclosure is to provide an air-curtain system of a vehicle, which can adjust an air discharge direction, an air discharge pressure, etc.

In order to achieve the objective of the present disclosure, there is provided an air-curtain system of a vehicle, including a plurality of air discharge units provided on a roof of a door side or trunk side of the vehicle, and adjusting a direction or pressure of discharged air by driving an actuator, an air supply system provided in the vehicle, connected at a plurality of ends to the air discharge units, and adjusting supply of the air to the air discharge unit as a plurality of guides provided therein are rotated, and a controller adjusting a flow rate of the air discharged from the air discharge unit by adjusting a rotation angle of each of the guides depending on an open or closed state of a door or trunk of the vehicle.

The controller may drive the actuator depending on the open or closed state of the door or trunk of the vehicle, thus adjusting the direction or pressure of the air discharged from the air discharge unit.

The air discharge unit may include a discharge port through which the air is discharged, and the discharge port may be rotated by driving the actuator to discharge the air to the roof or a lower side of the roof.

The discharge port may include a first discharge port that is relatively large in sectional area through which air is discharged, and a second discharge port that is relatively small in sectional area through which air is discharged.

The air supply system may include a roof duct that is provided in the roof and is a passage through which air flows, and a branch duct may be provided on each end of the roof duct to be connected to the air discharge unit.

The roof duct may be connected to a main duct that is provided on a rear side of the vehicle to receive air from the main duct, and the branch duct may be provided in a door-side roof of the vehicle or a trunk-side roof of the vehicle.

A plurality of guides may be provided in the roof duct to adjust a flow rate of air supplied to the air discharge unit by rotation.

The air discharge unit may be further provided on the roof of a seat side having no vehicle door.

When it is detected that the door or trunk of the vehicle is open, the controller may discharge air to the air discharge unit on a side where the opening is detected.

When it is detected that the door or trunk of the vehicle is open, the controller may adjust a rotation angle of the guide on a side where the opening is detected, thus increasing the flow rate of air discharged from the air discharge unit.

When it is detected that the door or trunk of the vehicle is open, the controller may drive the actuator on a side where the opening is detected, thus increasing the pressure of discharged air.

When a user requests dehumidification of a rear glass, the controller may increase the air flow rate of the air discharge unit on the trunk side.

When the user requests air conditioning inside the vehicle, the controller may adjust rotation of the guide and driving of the actuator, thus adjusting the direction or pressure of the air discharged from the air discharge unit.

The controller may determine whether there is a passenger for each seat, and may adjust the air discharge direction of the air discharge unit depending on presence or absence of the passenger.

When it is detected that the door or trunk of the vehicle is open, the controller may adjust the rotation angle of the guide on the side where the opening is detected, thus increasing the flow rate of the air discharged from the air discharge unit.

An air-curtain system of a vehicle according to the present disclosure is advantageous in that it can adjust an air discharge direction, an air discharge pressure, and the like, thus allowing various functions to be performed.

Although the present disclosure was provided above in relation to specific examples shown in the drawings, it is apparent to those skilled in the art that the present disclosure may be changed and modified in various ways without departing from the scope of the present disclosure, which is described in the following claims.

1. An air-curtain system of a vehicle, comprising:
a plurality of air discharge units provided on a roof of a door side or trunk side of the vehicle, each of the plurality of air discharge units configured to adjust a direction or pressure of air discharged thereby by driving an actuator;
an air supply system provided in the vehicle, connected at a plurality of ends to the plurality of air discharge units, the air supply system configured to adjust a supply of the air to each of the plurality of air discharge units as a plurality of guides provided therein are rotated; and
a controller configured to cause an adjustment to a flow rate of the air discharged from one or more of the air discharge units by causing an adjustment to a rotation angle of one or more of the plurality of guides depending on an open or closed state of a door or trunk of the vehicle.

2. The air-curtain system of claim 1, wherein the adjustment to the rotation angle of the one or more of the plurality of guides further comprises adjusting the direction or pressure of the air discharged from the one or more of the air discharge units.

3. The air-curtain system of claim 1, wherein each of the air discharge units comprise a discharge port through which the air is discharged, and wherein the discharge port is rotated by driving the actuator to discharge the air to the roof or a lower side of the roof.

4. The air-curtain system of claim 3, wherein the discharge port comprises a first discharge port through which air is discharged having a first sectional area; and a second discharge port through which the air is discharged having a second sectional area that is larger than the first sectional area.

5. The air-curtain system of claim 1, wherein the air supply system comprises a roof duct that is provided in the roof, the roof duct comprising a passage through which the air flows, wherein a branch duct is provided on each end of the roof duct configured to be connected to one of the plurality of air discharge units.

6. The air-curtain system of claim 5, wherein the roof duct is connected to a main duct that is provided on a rear side of the vehicle, the roof duct being configured to receive the air from the main duct, and wherein one or more of the branch ducts are provided in a door-side roof of the vehicle or a trunk-side roof of the vehicle.

7. The air-curtain system of claim 5, wherein a plurality of guides are provided in the roof duct, the plurality of guides configured to adjust, by rotation, a flow rate of the air supplied to the one or more of the air discharge units.

8. The air-curtain system of claim 1, wherein each of the plurality of air discharge units is provided on the roof of a seat side of the vehicle having no vehicle door.

9. The air-curtain system of claim 1, wherein the controller is configured to cause discharge of the air to the one or more of the air discharge units on a side where a vehicle door opening or a vehicle trunk opening is detected.

10. The air-curtain system of claim 1, wherein the controller is configured to cause an adjustment to the rotation angle of a guide of the plurality of guides on a side where a vehicle door opening or vehicle trunk opening is detected, to increase the flow rate of the air discharged from at least one of the plurality of air discharge units.

11. The air-curtain system of claim 1, wherein the controller is configured to cause a driving of the actuator on a side where a vehicle door opening or a vehicle trunk opening is detected, to increase the pressure of the air discharged from one of the plurality of air discharge units.

12. The air-curtain system of claim 1, wherein the controller is configured to cause an increase to the flow rate of the air of one of the plurality of air discharge units in response to a user request for dehumidification of a rear glass, the one of the plurality of air discharge units being disposed on the trunk side of the vehicle.

13. The air-curtain system of claim 1, wherein the controller is configured to cause:
the adjustment to the rotation angle of one of the plurality of guides; and
the driving of the actuator,
to adjust a direction or pressure of the air discharged from at least one of the air discharge units in response to a user request for air conditioning inside the vehicle.

14. The air-curtain system of claim 13, wherein the controller is further configured to determine whether there is a passenger for each seat, the controller further configured to cause adjustment to an air discharge direction of one or more of the air discharge units depending on a presence or absence of the passenger.

15. The air-curtain system of claim 13, wherein the controller is further configured to cause adjustment to the rotation angle of one guide of the plurality of guides in response to a detection that a vehicle door or vehicle trunk is open, the one guide being disposed on a side of the vehicle where the open vehicle door or open vehicle trunk is detected, wherein the adjustment to the rotation angle of the one guide causes an increase to the flow rate of the air discharged from at least one of the plurality of air discharge units.
